(19) United States
(12) Patent Application Publication
(10) Pub. No.: US 2026/0257489 A1
(43) Pub. Date: Sep. 3, 2026

(54) INK EJECTION APPARATUS, CONTROL METHOD, AND STORAGE MEDIUM

(71) Applicant: Konica Minolta, Inc., Tokyo (JP)

(72) Inventor: Hiroyuki TOKIMATSU, Tokyo (JP)

(21) Appl. No.: 19/548,458

(22) Filed: Feb. 24, 2026

(30) Foreign Application Priority Data
Mar. 3, 2025 (JP) 2025-033085

(51) Int. Cl. B41J 2/19; B41J 2/17

(52) U.S. Cl. CPC B41J 2/19; B41J 2/1707; B41J 2202/08

(57) ABSTRACT

An ink ejection apparatus includes: an ink ejector that ejects ink; a deaeration module including a gas permeable membrane that deaerates ink; a channel that communicates with the deaeration module; a pump that depressurizes the channel; and a hardware processor. When a predetermined condition under which deaeration of ink by the deaeration module is not required is met, the hardware processor at least either stops driving the pump or makes the channel to have an atmospheric pressure.

### CROSS-REFERENCE TO RELATED APPLICATIONS

The entire disclosure of Japanese Patent Application No. 2025-033085 filed on Mar. 3, 2025, is incorporated herein by reference in its entirety.

### BACKGROUND OF THE INVENTION

### Technical Field

The present disclosure relates to an ink ejection apparatus, a control method, and a storage medium.

### Description of Related Art

Conventionally, an ink ejection apparatus that ejects ink from an ink ejection section is known. When a gas is dissolved in ink, the dissolved gas causes a problem in the ink ejection apparatus.

In order to remove the gas dissolved in ink, a deaeration module that degasses the ink is generally provided in an ink supply channel through which the ink is supplied to the ink ejection section. The deaeration module includes, for example, a gas-permeable membrane. The gas-permeable membrane is connected to a pump via a vacuum channel. When the pump sucks the air, the inside of the vacuum channel and the gas-permeable membrane connected to the vacuum channel is depressurized and evacuated. When the ink is in contact with the outside of the gas permeable membrane the inside of which is depressurized, the gas dissolved in the ink permeates the gas permeable membrane. Thus, the ink is deaerated.

However, in the deaeration process of such a deaeration module, not only the dissolved gas but also a small amount of the liquid components of the ink may pass through the gas permeable membrane and leak into the vacuum channel. When the liquid components of the leaked ink reaches the pump through the vacuum channel, malfunction of the pump is caused. To prevent the liquid components from reaching the pump, a trap is provided in the vacuum channel to store the liquid components of the ink. Cleaning and maintenance of the trap is periodically performed to prevent overflow of the ink from the trap.

The deaeration module is not limited to the above configuration in which the inside of the gas permeable membrane is depressurized. There is a deaeration module configured to depressurize the outside of the gas permeable membrane, for example. However, even in the deaeration module that depressurizes the outside of the gas permeable membrane, the liquid components of the ink may pass through the gas permeable membrane and leak to the vacuum channel during the deaeration process, as in the deaeration module that depressurizes the inside of the gas permeable membrane. Therefore, a trap is generally provided in the vacuum channel, and cleaning maintenance is periodically performed.

The trap having a large volume requires a correspondingly wide installation space. Further, when the trap has a large volume, the volume of the entire vacuum channel increases accordingly, and the time required for the pump to decompress the inside of the gas permeable membrane increases. Therefore, it is preferable that the volume of the trap be as small as possible. On the other hand, with a smaller volume of the trap, the liquid components of the ink are likely to overflow from the trap. If the execution frequency of the cleaning maintenance is increased to prevent the liquid component of the ink from overflowing, the ink ejection productivity is reduced accordingly. Further, the labor cost for the cleaning maintenance is increased.

To solve such a problem, for example, Japanese U.S. Pat. No. 7,354,644 describes a configuration in which the amount of the liquid component of the ink having entered the trap is detected, so that cleaning maintenance can be performed only at necessary timing.

### SUMMARY OF THE INVENTION

However, the invention described in Japanese U.S. Pat. No. 7,354,644 is aimed at performing cleaning maintenance at an appropriate timing and cannot sufficiently restrain a decrease in ink ejection productivity or restrain labor costs. It is desired to prevent the liquid component of the ink from passing through the gas permeable membrane of the deaeration module and leaking into the vacuum channel.

The present disclosure has been made in view of such circumstances. An object of the present invention is to provide an ink ejection apparatus, a control method, and a storage medium that can prevent the liquid components of ink from passing through a gas permeable film of a deaeration module.

To achieve at least one of the abovementioned objects, according to an aspect of the present invention, an ink ejection apparatus includes: an ink ejector that ejects ink; a deaeration module including a gas permeable membrane that deaerates ink; a channel that communicates with the deaeration module; a pump that depressurizes the channel; and a hardware processor, wherein when a predetermined condition under which deaeration of ink by the deaeration module is not required is met, the hardware processor at least either stops driving the pump or makes the channel to have an atmospheric pressure.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a side cross-sectional view of an ink jet recording apparatus;

FIG. 2 is a schematic configuration diagram of a liquid delivery section in the ink jet recording apparatus;

FIG. 3 is a cross-sectional side view of a deaeration module;

FIG. 4 is a block diagram of the inkjet recording apparatus;

FIG. 5 is a flowchart of an image forming process; and

FIG. 6 is a graph showing how the liquid amount in the ink trap changes in a case where the deaeration process is always performed and in a case where the deaeration process is not performed when not necessary.

### DETAILED DESCRIPTION

Hereinafter, one or more embodiments of the present invention will be described with reference to the drawings. However, the scope of the invention is not limited to the disclosed embodiments. In the following description, components having the same functions and configurations are denoted by the same reference numerals, and description thereof will be omitted.

### Overall Configuration of Inkjet Recording Apparatus

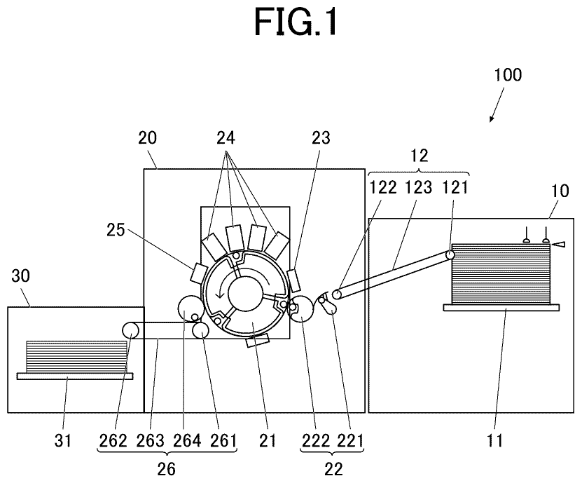

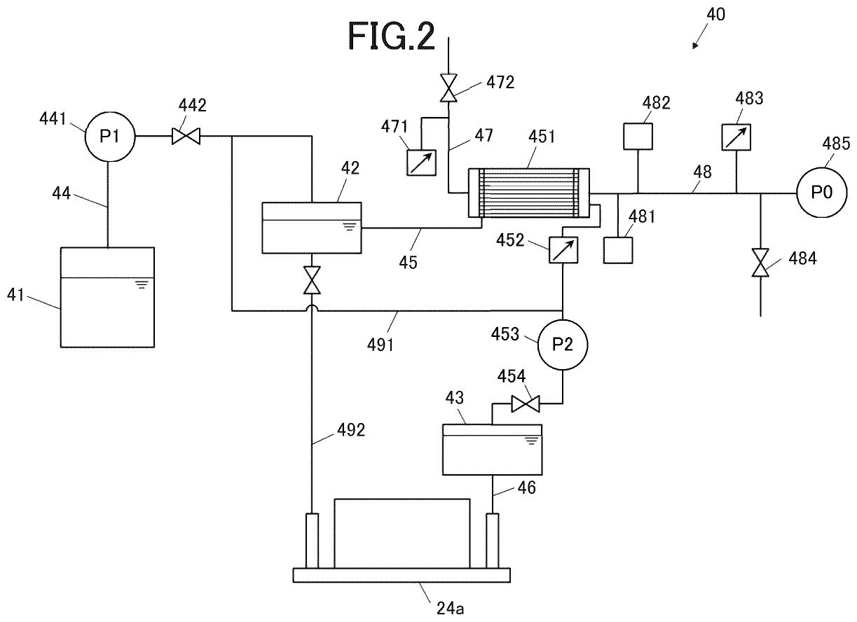

FIG. 1 is a side cross-sectional view illustrating a main configuration of an inkjet recording apparatus 100 as an embodiment of an ink ejection apparatus. The inkjet recording apparatus 100 includes, for example, a sheet feed section 10, an image forming section 20, a sheet ejection section 30, a liquid delivery section 40 (see FIG. 2), a controller 50 (hardware processor), a notification section 60, and an operation input section 70 (operation receiver) (see FIG. 4 for all).

The inkjet recording apparatus 100 conveys a recording medium from the sheet feed section 10 to the image forming section 20 under the control of the controller 50. Then, the controller 50 supplies the ink to the image forming section 20 by the liquid delivery section 40 and forms an image on the recording medium by ejecting ink droplets from the image forming section 20 by an inkjet method. The controller 50 ejects the recording medium on which the image has been formed to the sheet ejection section 30.

Hereinafter, a case where the recording medium is paper will be described as an example. The recording medium is not limited thereto and may be, for example, textiles or plastic film.

### Sheet Feed Section

The sheet feed section 10 stores the recording medium before image formation. The sheet feed section 10 conveys the recording medium to the image forming section 20 under the control of the controller 50. The sheet feed section 10 includes a sheet feed tray 11 and a conveyance section 12.

### Sheet Feed Tray

The sheet feed tray 11 is a plate member for storing the recording medium. On the sheet feed tray 11, one or more pieces of the recording medium can be placed. The sheet feed tray 11 moves up and down according to the amount of the recording medium placed thereon. By such vertical movement, the sheet feed tray 11 is held at a position where the uppermost recording medium is conveyed by the conveyance section 12. In FIG. 1, one sheet feed tray 11 is exemplified, but the present invention is not limited thereto. The sheet feed trays 11 may be provided by the number corresponding to the types of recording media to be stored.

### Conveyance Section

The conveyance section 12 conveys the recording medium from the sheet feed tray 11 to the image forming section 20. The conveyance section 12 includes a conveyance mechanism. The conveyance mechanism drives a belt 123 to convey the recording medium on the belt 123. The belt 123 has a ring shape, and the inner side of the ring is supported by a plurality of rollers 121 and 122. The conveyance section 12 delivers the uppermost recording medium placed on the sheet feed tray 11 onto the belt 123, and conveys the recording medium along the belt 123.

### Image Forming Section

The image forming section 20 records an image on the recording medium in cooperation with the liquid delivery section 40 under the control of the controller 50. The image forming section 20 includes an image forming drum 21, a handover unit 22, a sheet heating section 23, a head unit 24, an irradiation section 25, and a delivery section 26.

### Image Forming Drum

The image forming drum 21 is a main conveyance section that carries the recording medium along its cylindrical outer periphery surface and conveys the recording medium with rotation. The conveyance surface of the image forming drum 21 faces the sheet heating section 23, the head unit 24, and the irradiation section 25, and performs the image forming process on the conveyed recording medium.

### Handover Unit

The handover unit 22 is provided at a position between the conveyance section 12 and the image forming drum 21. The handover unit 22 includes a claw 221 and a handover drum 222.

The claw 221 is a cylindrical member that supports one end of the recording medium conveyed by the conveyance section 12. The handover drum 222 is a member that guides the recording medium held by the claw 221.

The handover unit 22 picks up the recording medium on the conveyance section 12 with the claw 221 and places the recording medium along the outer periphery surface of the handover drum 222. By such operations, The handover unit 22 hands over the recording medium to the image forming drum 21.

### Sheet Heating Section

The sheet heating section 23 includes, for example, a heating wire, and generates heat in response to energization. The output of the sheet heating section 23 is controlled by the controller 50, The sheet heating section 23 generates heat such that the recording medium passing through the vicinity thereof has a predetermined temperature. The sheet heating section 23 is provided in the vicinity of the outer periphery surface of the image forming drum 21 and on the upstream side of the head unit 24 in the conveyance direction of the recording medium.

A temperature sensor (not illustrated) is provided in the vicinity of the sheet heating section 23. With the temperature sensor, the controller 50 senses a temperature around the sheet heating section 23. The controller 50 controls the output of the sheet heating section 23 based on the detected temperature.

### Head Unit

The head units 24 include, for example, inkjet heads 24a (see FIG. 2) as ink ejectors. The head units 24 form the image by ejecting ink droplets onto the recording medium from nozzles. The head units 24 corresponding to the colors of C (cyan), M (magenta), Y (yellow), and K (black) are provided. In FIG. 1, the head units 24 corresponding to the respective colors of Y, M, C, and K are provided in this order from the upstream of the conveyance direction of the recording medium.

Here, the direction perpendicular to the conveyance direction of the recording medium in a plan view is referred to as a main scanning direction. The head units 24 have a width that covers the entire width of the recording medium in the main scanning direction. That is, the inkjet recording apparatus 100 is a line-head-type inkjet recording apparatus that uses the one-pass method. For each of the head units 24, multiple inkjet heads 24a as ink ejectors are arranged. The number of head units 24 may be greater than or less than four. Further, a single inkjet head 24a may constitute the head unit 24.

The ink ejected by the head units 24 is, for example, ultraviolet curable ink (UV ink). The ultraviolet curable ink contains, for example, an ultraviolet curable resin. The ultraviolet curable resin contains a monomer and a polymerization initiator. When the ink containing the ultraviolet curable resin is irradiated with ultraviolet rays, the monomer is polymerized and cured by the action of the polymerization initiator, and the ink is fixed to the recording medium.

The ink ejected by the head units 24 may contain a gelling agent. The ink containing the gelling agent changes in phase between a gel state and a liquid (sol) state depending on the temperature. The ink containing the gelling agent has a phase change temperature of, for example, about 40 to 100° C., and is uniformly liquefied (solated) by being heated to a phase change temperature or higher. On the other hand, the ink containing the gelling agent is gelled at about normal room temperature, that is, about 0 to 30° C. Therefore, the ink in the head units 24 is heated to an appropriate temperature by an ink heater or the like (not illustrated) to be in a sol state. After the ink is ejected and lands on the recording medium, the ink moderately becomes a gel state while the recording medium is conveyed by the image forming drum 21.

### Irradiation Section

The irradiation section 25 includes, for example, a fluorescent tube such as a low-pressure mercury lamp. The irradiation section 25 emits energy rays such as ultraviolet rays by light emission of the fluorescent tube. The irradiation section 25 is provided near the outer peripheral surface of the image forming drum 21. The irradiation section 25 is provided at a position on the downstream side of the head units 24 in the conveyance direction of the recording medium. The irradiation section 25 irradiates the recording medium on which the ink has been ejected with energy rays. In a case where the ink on the recording medium is UV ink, the ink is cured by the action of the energy rays.

The fluorescent tube that emits ultraviolet light is not limited to a low-pressure mercury lamp. The fluorescent tube may be a mercury lamp having an operating pressure of a few hundred Pa to 1 MPa, for example. The fluorescent tube may be a light source usable as a bactericidal lamp, for example, a cold-cathode tube, an ultraviolet laser light source, a metal halide lamp, or a light-emitting diode. The fluorescent tube is desirably a power saving light source capable of emitting ultraviolet rays with higher illuminance. The fluorescent tube is, for example, the light-emitting diode. The energy rays are not limited to the ultraviolet rays and may be the energy rays having a property of curing the ink depending on the property of the ink. The light source is changed depending on the energy rays.

In the above description, the head units 24 discharge the ultraviolet curable ink or the ink containing the gelling agent. However, the present disclosure is not limited thereto. The ink ejected by the head units 24 may be water-based ink or ink having other physical properties.

### Delivery Section

The delivery section 26 includes a conveyance mechanism. The conveyance mechanism drives a ring-shaped belt 263 the inside of which is supported by a plurality of rollers 261 and 262 to convey the recording medium. The delivery section 26 includes a cylindrical handover roller 264. The handover roller 264 hands over the recording medium from the image forming drum 21 to the conveyance mechanism. The delivery section 26 conveys the recording medium delivered onto the belt 263 by the handover roller 264 and sends it to the sheet ejection section 30.

### Sheet Ejection Section

The recording medium on which the image has been formed by the image forming section 20 is discharged to the sheet ejection section 30. The sheet ejection section 30 includes a plate-shaped sheet ejection tray 31. The recording medium sent from the image forming section 20 by the delivery section 26 is placed on the sheet ejection tray 31. The sheet ejection section 30 stores the recording medium until the user takes out the recording medium.

### Liquid Delivery Section

FIG. 2 is a schematic configuration diagram of the liquid delivery section 40. The liquid delivery section 40 includes multiple main tanks 41 that store the respective colors of ink. The liquid delivery section 40 supplies the ink of each color in the main tank 41 to the inkjet heads 24a of each head unit 24. By such operations, the liquid delivery section 40 allows the ink of each color to be dischargeable from the nozzles.

As illustrated in FIG. 2, the liquid delivery section 40 includes a main tank 41, a first sub-tank 42, and a second sub-tank 43. The liquid delivery section 40 also includes a deaeration module 451 that removes a dissolved gas in the ink to deaerate the ink before delivering the ink to the head unit 24.

### Main Tank

The main tank 41 stores ink to be supplied to each part of the liquid delivery section 40. The main tank 41 is, for example, a rigid sealed tank made of metal. The main tank 41 is connected to the first sub-tank 42 via a supply tube 44.

### First Sub-Tank

The first sub-tank 42 is one or more ink inflow chambers having a smaller volume than the main tank 41. The ink pumped out from the main tank 41 by a supply pump 441 described later is stored in the first sub-tank 42. The first sub tank 42 reduces pressure fluctuation caused by the pulsation of the supply pump 441 when the supply pump 441 supplies the ink from the main tank 41. The first sub-tank 42 is connected to the second sub-tank 43 via a liquid delivery tube 45.

### Second Sub-Tank

The second sub-tank 43 is a small tank chamber that temporarily stores the ink degassed by the deaeration module 451. The capacity of the second sub-tank 43 is substantially the same as that of the first sub-tank 42, for example. The second sub-tank 43 is connected to the inlet of each inkjet head 24 via a supply channel 46. The ink in the second sub-tank 43 is supplied to each inkjet head 24a according to the amount of ink to be discharged from the nozzles. Further, the second sub-tank 43 is provided with a back pressure adjusting means (not illustrated) for preventing ink leakage by applying an appropriate negative pressure to the inkjet head 24a.

### Supply Tube

The supply tube 44 is an ink channel that connects the main tank 41 and the first sub tank 42. The supply tube 44 is provided with a supply pump 441 and a supply valve 442. The supply pump 441 and the supply valve 442 operate under the control of the controller 50. When the supply valve 442 is opened, the ink in the main tank 41 is supplied to the first sub-tank 42 via the supply tube 44 by the driven supply pump 441. The entire main tank 41 is replaceable. Further, the main tank 41 is attachable to and detachable from the supply tube 44 regardless of the driving state of the supply pump 441.

### Liquid Delivery Tube

The liquid delivery tube 45 is an ink channel that connects the first sub-tank 42 and the second sub-tank 43. The liquid delivery tube 45 is provided with the deaeration module 451, a flow rate sensor 452, and a liquid delivery pump 453.

### Deaeration Module

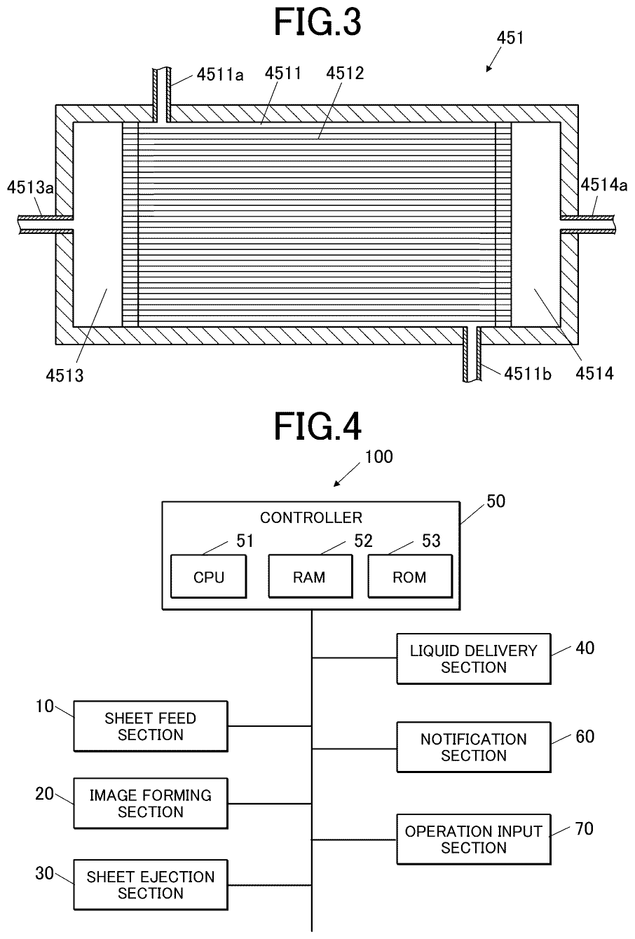

FIG. 3 shows an enlarged cross-sectional view of the deaeration module 451. The deaeration module 451 removes a gas dissolved in the ink that has flowed into the deaeration module 451 and discharges the deaerated ink. The deaeration module 451 includes an ink flow chamber 4511, a gas permeable membrane 4512, a first vacuum chamber 4513, and a second vacuum chamber 4514.

### Ink Flow Chamber

The ink flow chamber 4511 is provided in the central part of the inside of the casing of the deaeration module 451. The ink flow chamber 4511 includes an ink inflow port 4511a and receives inflow of the ink before deaeration from the first sub-tank 42. The ink flow chamber 4511 includes an ink outflow port 4511b to send the deaerated ink to the second sub-tank 43.

As illustrated in FIG. 3, the ink inflow port 4511a and the ink outflow port 4511b are preferably provided at the first and second end sides opposite to each other of the ink flow chamber 4511. As illustrated in FIG. 3, it is particularly preferable that the ink inflow port 4511a and the ink outflow port 4511b are provided on a substantially diagonal line of the ink flow chamber 4511. According to such a configuration, the ink is more likely to be in contact with the gas permeable membrane 4512, so that the deaeration efficiency of the deaeration module 451 is increased.

### Gas Permeable Membrane

The gas permeable membrane 4512 has a tubular shape, and its membrane surface has gas permeability. The gas permeable membrane 4512 is, for example, a hollow fiber membrane that has many hollow fine fiber structures. The large number of hollow finer fiber structures are bundled and arranged to extend in the axial direction of the ink flow chamber 4511.

Furthermore, as illustrated in FIG. 3, the gas permeable membrane 4512 is disposed to connect the first vacuum chamber 4513 to the second vacuum chamber 4514. Therefore, the first end of the gas permeable membrane 4512 is connected to the atmosphere via a hollow fiber valve 472 to be described later. In addition, in the gas permeable membrane 4512, the second end opposite to the first end communicates with a vacuum pump 485 to be described later.

The gas permeable membrane 4512 is preferably made of silicone, for example. This is because silicone has high permeability of gases dissolved in the ink. Further, silicone has high heat resistance and ink resistance.

### First Vacuum Chamber

The first vacuum chamber 4513 is provided at the first end of the deaeration module 451. The first vacuum chamber 4513 is formed by being partitioned from the ink flow chamber 4511 by a partition wall. The side of the first vacuum chamber 4513 opposite the ink flow chamber 4511 is connected to the atmosphere by a first vacuum channel 47 to be described below.

### Second Vacuum Chamber

The second vacuum chamber 4514 is provided at the second end side of the deaeration module 451 opposite to the first vacuum chamber 4513. The second vacuum chamber 4514 is formed by being partitioned from the ink flow chamber 4511 by a partition wall. The second vacuum chamber 4514 is connected to the ink trap 481 by a second vacuum channel 48 to be described below.

Although the form of the deaeration module 451 is not particularly limited, it is preferable to use a sheet in which the gas permeable membranes 4512 are woven into a mesh, for example. With such a configuration, fine pores are formed in the gas permeable membranes 4512, and the entire ink is more likely to pass through the pores of the gas permeable membrane 4512. This increases the deaeration efficiency. Furthermore, with such a configuration, the flexible gas permeable membrane 4512 can have a certain strength.

### Flow Rate Sensor

Referring to FIG. 2, the flow rate sensor 452 is provided in the vicinity of the deaeration module 451 on the liquid delivery tube 45. The flow rate sensor 452 detects the flow rate of ink flowing through the liquid delivery tube 45 and transmits the detected flow rate to the controller 50. Although the flow rate sensor 452 is provided on the downstream side of the deaeration module 451 in the liquid delivery direction as an example in FIG. 2, the configuration is not limited thereto. The flow rate sensor 452 may be provided on the upstream side of the deaeration module 451 in the liquid delivery direction.

### Liquid Delivery Pump

The liquid delivery pump 453 operates under the control of the controller 50. The liquid delivery pump 453 sends out, to the second sub tank 43, the ink having flowed out from the ink outflow port 4511b of the deaeration module 451.

### First Vacuum Channel

The first vacuum channel 47 is an air channel communicating with the first end of the deaeration module 451. The first vacuum channel 47 is provided with a first pressure sensor 471 and the hollow fiber valve 472.

### First Pressure Sensor and Hollow Fiber Valve

The first pressure sensor 471 detects the pressure value of the first vacuum channel 47 and sends the pressure value to the controller 50. The hollow fiber valve 472 is an electromagnetic valve. The hollow fiber valve 472 opens or closes the first vacuum channel 47 to the atmosphere according to control signals of the controller 50.

### Second Vacuum Channel

The second vacuum channel 48 is an air channel communicating with the second end of the deaeration module 451. The second vacuum channel 48 is provided with the ink trap 481, an ink leakage detector 482, a second pressure sensor 483, an atmospheric relief valve 484, and a vacuum pump 485.

### Ink Trap

The ink trap 481 stores therein the liquid components of the ink, small amounts of pigment, and so forth that slightly leak from the gas permeable membrane 4512 and enter the second vacuum channel 48 in the normal state. The liquid components of the ink stored in the ink trap 481 include a monomer when the ink is UV ink, for example.

### Ink Leakage Detector

The ink leakage detector 482 detects the ink that has leaked from the gas permeable membrane 4512 and from the ink trap 481 owing to a malfunction of the deaeration module 451. Specifically, the ink leakage detector 482 consists of a photosensor. The light emitter and the light receiver of the photosensor are positioned with the second vacuum channel 48 in-between. The ink leakage detector 482 detects leakage of ink when the light receiving state changes owing to the ink adhering to the second vacuum channel 48.

### Second Pressure Sensor and Atmospheric Relief Valve

The second pressure sensor 483 sequentially transmits the detected pressure value in the second vacuum channel 48 to the controller 50. The atmospheric relief valve 484 is an electromagnetic valve that can be opened and closed under the control of the controller 50. The atmospheric relief valve 484 is provided between the ink trap 481 and the vacuum pump 485. The atmospheric relief valve 484 is opened when the second vacuum channel 48 is connected to the atmosphere.

### Vacuum Pump

The vacuum pump 485 is, for example, a diaphragm pump. Specifically, the vacuum pump 485 includes a pump chamber having an extendable diaphragm. In addition, the vacuum pump 485 includes a driving source or the like that operates the diaphragm so that the volume of the pump chamber expands and contracts. The pump chamber includes a suction port having a check valve that allows only inflow of fluid from the outside. The pump chamber also includes a discharge port having a check valve that allows only outflow of fluid from the inside.

The vacuum pump 485 sucks the air in the gas permeable membrane 4512 under the control of the controller 50. By the operation of the vacuum pump 485, foreign substances in the gas permeable membrane 4512 are removed, and the pressure in the gas permeable membrane 4512 is reduced. Therefore, the gases dissolved in the ink that flows into the ink flow chamber 4511 and that comes into contact with the outer membrane surface of the gas permeable membrane 4512 selectively permeates the membrane surface. Thus, the ink is deaerated. The dissolved gas having passed through the gas permeable membrane 4512 is discharged by the vacuum pump 485.

### Circulation Channel

The circulation channel 49 is a channel through which the ink having flowed out from the first sub-tank 42, having passed through the deaeration module 451, and having been deaerated, returns to the first sub-tank 42. Thus, the ink is circulated through the circulation channel 49. The circulation channel 49 includes a first circulation channel 491 and a second circulation channel 492.

### First Circulation Channel

The first circulation channel 491 is a channel that connects (i) a predetermined portion of the liquid delivery tube 45 on the downstream side of the deaeration module 451 and on the upstream side of the liquid delivery pump 453 in the liquid delivery direction and (ii) a predetermined portion of the supply tube 44 on the downstream side of the supply valve 442 in the liquid delivery direction. The first circulation channel 491 is provided with a first circulation pump (not illustrated). When the operation of the liquid delivery pump 453 is stopped and the supply valve 442 is closed, the controller 50 drives the first circulation pump, so that the ink that has flowed out of the first sub-tank 42 and has been deaerated by passing through the deaeration module 451 returns to the first sub-tank 42 again for circulation.

### Second Circulation Channel

The second circulation channel 492 is a channel that connects the outlet of the inkjet head 24a and the first sub-tank 42. The second circulation channel 492 is provided with a second circulation pump (not illustrated). The controller 50 drives the second circulation pump, so that the ink that was not ejected from the inkjet head 24a flows through the second circulation channel 492 and collected by the first sub tank 42.

### Controller

FIG. 4 is a block diagram showing the configuration of the inkjet recording apparatus 100. The controller 50 controls each section constituting the inkjet recording apparatus 100. As shown in FIG. 4, the controller 50 is connected to each section constituting the inkjet recording apparatus 100. The controller 50 includes a central processing unit (CPU) 51, a random access memory (RAM) 52, and a read only memory (ROM) 53.

The CPU 51 reads various programs and data corresponding to processing contents from the storage device, such as the ROM 53, and executes the programs. The CPU 51 also controls the operation of each section of the inkjet recording apparatus 100 according to the executed processing content.

### RAM

The RAM 52 temporarily stores various programs and data to be processed by the CPU 51.

### ROM

The ROM 53 is a non-volatile storage section, such as a hard disk drive (HDD), a solid state drive (SSD), or a flash memory. The ROM 53 stores various programs and data to be read by the CPU 51.

### Notification Section

The notification section 60 provides notification of various kinds of information under the control of the controller 50. The notification section 60 is, for example, a display part having a screen, a speaker that emits predetermined sounds, or a communication section that can communicate with other devices via a network.

### Operation Input Section

The operation input section 70 receives various inputs related to the operations of the inkjet recording apparatus 100 in response to operations by the user. The operation input section 70 includes a touch-screen-type input display device, keys for upward, downward, leftward, and rightward movements for selecting and sending data, and various function keys. The operation input section 70 outputs pressed-key signals of keys pressed by the user and operation signals of a mouse to the CPU 51 of the controller 50.

### Image Forming Process

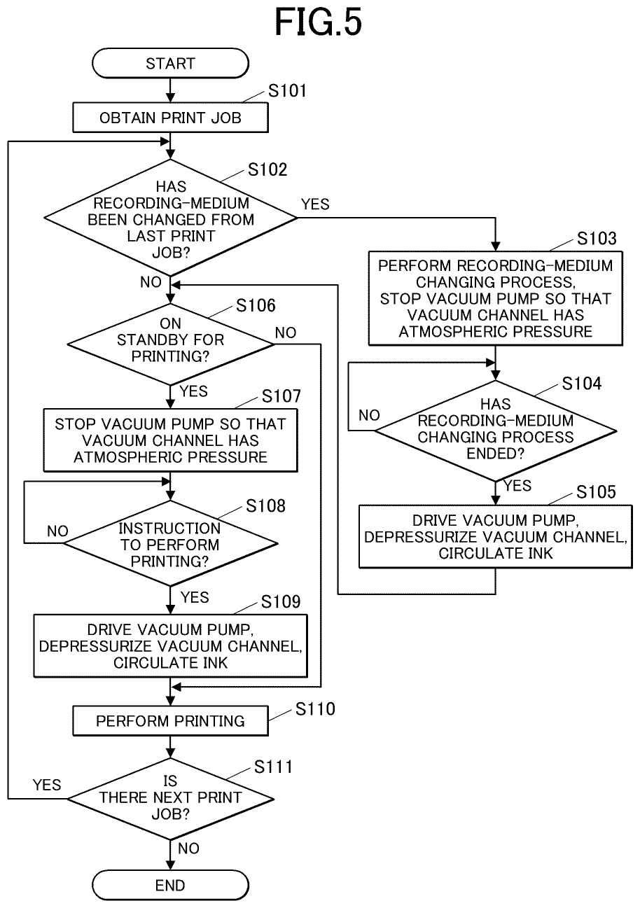

The image forming process to be performed by the controller 50 of the inkjet recording apparatus 100 will be described with reference to the flowchart of FIG. 5. In the present embodiment, unless otherwise specified, in the inkjet recording apparatus 100 in the ON state, the controller 50 drives the vacuum pump 485 while keeping the atmospheric relief valve 484 closed, so that the deaeration module 451 deaerates the ink.

First, the controller 50 of the inkjet recording apparatus 100 acquires a print job from an external device (not illustrated) (step S101). Based on the content of the acquired print job, the controller 50 determines whether the target recording medium to which the ink is ejected has been changed from the previous print job (step S102).

When the target recording medium has been changed from the previous print job (step S102: Yes), the controller 50 causes the sheet feed section 10 to perform a recording-medium changing process. Further, the controller 50 opens the atmospheric relief valve 484 so that the second vacuum channel 48 communicates with the atmosphere and has the atmospheric pressure; and the controller 50 stops the operation of the deaeration module 451 (step S103: control step).

It takes a certain time until the sheet feed section 10 ends the recording-medium changing process after the controller 50 causes the sheet feed section 10 to do the recording-medium changing process. While the controller 50 is causing the sheet feed section 10 to perform the recording-medium changing process, at least the inkjet head 24a does not eject the ink. Therefore, the ink need not be deaerated. At such timing, driving of the vacuum pump 485 is stopped, and the second vacuum channel 48 is made to have the atmospheric pressure, so that the ink deaeration process stops. This can prevent the liquid components of the ink from passing through the gas permeable membrane 4512 and prevent an increase of the ink amount in the ink trap 481.

When the second vacuum channel 48 has the atmospheric pressure, the inside of the gas permeable membrane 4512 is not evacuated even when the vacuum pump 485 is driven. Therefore, deaeration is not performed. In the above description, (i) driving of the vacuum pump 485 is stopped, and (ii) the second vacuum channel 48 is made to have the atmospheric pressure. At least either of (i) and (ii) should be performed. In the above description, the second vacuum channel 48 is made to have the atmospheric pressure by opening the atmospheric relief valve 484. However, the method of making the second vacuum channel 48 to have the atmospheric pressure is not limited thereto.

In the present disclosure, changing the recording medium is not limited to changing the types of recording medium (e.g., changing from plain paper to coated paper). Changing the recording medium also includes changing the recording medium from first plain paper having a predetermined size/thickness to second plain paper having a different size/thickness, for example.

The controller 50 determines whether the recording-medium changing process has been completed (step S104). When the recording-medium changing process has not been completed (step S104: No), the controller 50 proceeds to step S104 and continuously performs the recording-medium changing process. When the recording-medium changing process has ended (step S104: Yes), the controller 50 performs the ink deaeration process in preparation for printing. Specifically, the controller 50 closes the atmospheric relief valve 484 and then drives the vacuum pump 485 to depressurize the second vacuum channel 48, thereby performing the ink deaeration process.

The controller 50 stops the operation of the liquid delivery pump 453 for a predetermined time, and in the state where the supply valve 442 is closed, the controller 50 drives the first circulation pump. By such control, the controller 50 resends the ink in the deaeration module 451, in which the air is dissolved via the gas permeable membrane 4512, to the deaeration module 451, so that the ink is deaerated (step S105).

After the ink deaeration process is performed or when the target recording medium has not been changed from the previous print job (step S102: No), the controller 50 determines whether the inkjet recording apparatus 100 is in a printing standby state (step S106). The printing standby state refers to a state in which printing preparation has been completed but an instruction to perform printing has not been received from the user via the operation input section 70 for a predetermined time.

When the inkjet recording apparatus 100 is in the printing standby state (step S106: Yes), the inkjet head 24a does not eject ink, and the ink does not need to be deaerated. Therefore, the controller 50 stops the deaeration process as in step S103 (step S107: control step).

The controller 50 determines whether an instruction to execute printing has been received from the user via the operation input section 70 (step S108). When the instruction has not been received (step S108: No), the controller 50 proceeds to step S108 and continues to wait until receiving the instruction. When the instruction has been received (step S108: Yes), the controller 50 executes, in the same manner as step S105, the ink deaeration process and ink circulation process in preparation for performing the print job (step S109). After performing the ink deaeration process and ink circulation process or when determining that the inkjet recording apparatus 100 is not in the printing standby state (i.e., when the instruction to execute printing has been received from the user via the operation input section 70) (step S106: No), the controller 50 executes the print job (step S110).

After the print job is completed, the controller 50 determines whether a subsequent print job has been received (step S111). If there is a subsequent print job (Step S111: YES), the controller 50 proceeds to step S102. When there is no subsequent print job (step S111: No), the controller 50 ends the image forming process.

### Advantageous Effects of Embodiment

As described above, the inkjet recording apparatus 100 as an ink ejection apparatus includes the inkjet head 24a as an ink ejector that ejects ink. The ink ejection apparatus further includes: the deaeration module 451 including the gas permeable membrane 4512 that deaerates ink; the second vacuum channel 48 that communicates with the deaeration module 451; the vacuum pump 485 that depressurizes the channel; and the controller 50. When predetermined conditions in which the deaeration of ink by the deaeration module 451 is not required are satisfied, the controller 50 at least either (i) stops driving the pump or (ii) makes the channel to have the atmospheric pressure.

In the present embodiment, the predetermined conditions include: (i) the controller 50 has completed preparation for ink ejection by the ink ejectors, and (ii) the operation input section 70 has not received an instruction to eject ink for a predetermined time. The conditions further include: (iii) the controller 50 is performing the recording-medium changing process of changing the recording medium, onto which the ink is to be ejected by the ink ejectors.

According to such a configuration, the ink deaeration process by the deaeration module 451 is stopped at timings when the ink need not be deaerated, by stopping driving the vacuum pump 485 or by making the second vacuum channel 48 to have the atmospheric pressure. When the deaeration process is performed even though the ink need not be deaerated, the liquid components of ink unnecessarily pass through the gas permeable membrane 4512, which requires frequent cleaning maintenance of the ink trap 481. According to the present embodiment, such an increase in the frequency of cleaning maintenance is restrained.

When the predetermined conditions are not satisfied, the inkjet recording apparatus 100 evacuates the second vacuum channel 48 by driving the vacuum pump 485. According to such a configuration, the deaeration of the ink is performed at timings when the deaeration of ink is required. Therefore, malfunctions caused by insufficient deaeration of ink can be suppressed.

Furthermore, the inkjet recording apparatus 100 includes the first circulation channel 491 as part of the circulation channel 49. The first circulation channel 491 flows the ink that has passed through the deaeration module 451 back to the upstream side of the deaeration module 451 in the liquid delivery direction. When the predetermined conditions are not satisfied, the controller 50 performs control such that the ink in the deaeration module 451 flows into the circulation channel 49. According to such a configuration, it is possible to deaerate the ink in which the gases are dissolved in the deaeration module 451 owing to the stop of the deaeration process. Thus, malfunctions caused by the dissolution of gases in the ink can be restrained.

The inkjet recording apparatus 100 ejects ultraviolet curable ink. In the above configuration, the UV monomer is stored in the ink trap 481 as the liquid components of the ink. Since clearing the UV monomer is particularly difficult, the present disclosure is particularly suitable with respect to the UV ink.

### Other Configurations

The scope of the present disclosure is not limited to the above-described embodiment but includes the scope of the invention described in the claims and the scope of equivalents thereof.

For example, when there is no subsequent print job after one print job is completed, the image forming process is ended in the above embodiment. However, the present invention is not limited thereto. Even if there is no subsequent print job at the end of one print job, it is possible to receive a new print job within a predetermined time, for example. When another print job is acquired within a predetermined time after completion of one print job, the controller 50 may proceed to step S102. On the other hand, when another print job is not acquired within a predetermined time after completion of one print job, the controller 50 may stop the deaeration process by the deaeration module 451 until another print job is acquired.

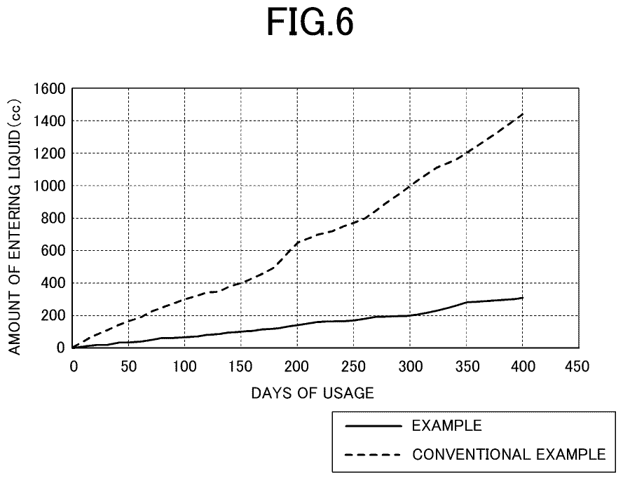

FIG. 6 is a graph of the cumulative amount of liquid components of ink entering the second vacuum channel 48. In FIG. 6, the dashed line represents a comparative example (conventional example) in which the vacuum pump 485 was driven constantly to perform the deaeration process when the inkjet recording apparatus 100 was on. In FIG. 6, the solid line represents an example in which the deaeration process by the deaeration module 451 was stopped after 30 seconds from the completion of the print job, and the deaeration process by the deaeration module 451 was performed at the time of performing printing. In FIG. 6, the horizontal axis represents the number of days the inkjet recording apparatus 100 was used, and the vertical axis represents the cumulative amount of liquid having entered the ink trap 481. As shown in FIG. 6, when the inkjet recording apparatus 100 is used for 400 days, the amount of liquid entering the ink trap 481 in the example, in which the above control was performed, is four times less than that in the conventional example.

When the controller 50 receives, via the operation input section 70, an instruction to decrease the rotation speed of the image forming drum 21 from the user, it takes time to return the rotational speed to the original speed and execute the image forming process. In such a case, the controller 50 may stop the deaeration process by the deaeration module 451. For another example, when the controller 50 receives an instruction to shift into a state in which it can be determined that printing will not be performed for a predetermined time, the controller 50 may stop the deaeration process by the deaeration module 451. The state in which it can be determined that printing will not be performed for a predetermined time refers to, for example, a state in which the inkjet head 24a or the image forming drum 21 is idled and the temperature is lowered. For another example, the state refers to a state in which a sheet registration mode is being performed. In the sheet registration mode, information on a recording medium to be used for a print job is registered in the ROM 53.

In the above description, when the deaeration process by the deaeration module 451 is resumed, the ink circulation process is performed by flowing the ink in the first circulation channel 491. However, the present disclosure is not limited thereto. The ink circulation process may be performed by flowing the ink in the second circulation channel 492. When the circulation process is performed using the second circulation channel 492, the ink drips from the nozzles, and the nozzle faces need to be wiped, unless the inkjet head 24a is compatible with such head circulation. It is therefore preferable to use the first circulation channel 491 in deaerating the ink in the deaeration module 451, as described above.

In the above description, the external-circulation type deaeration module 451 is used that evacuates the inside of the gas permeable membrane 4512 and that allows the ink to flow the outside of the gas permeable membrane 4512. The invention is not limited thereto, though. The deaeration module 451 may be an internal-circulation type that allows the ink to flow inside the gas permeable membrane 4512 and that deaerates the ink by evacuating the outside of the gas permeable membrane 4512.

Although the HDD is used as a computer-readable medium for storing the program of the present disclosure in the above, the present disclosure is not limited to this example. As another computer-readable medium, a portable recording medium such as a CD-ROM can be applied. Furthermore, a carrier wave is also applied as a medium for providing data of the program according to the present disclosure via a communication line.

Although embodiments of the present invention have been described and illustrated in detail, the disclosed embodiments are made for purposes of illustration and example only and not limitation. The scope of the present invention should be interpreted by terms of the appended claims.

What is claimed is:

1. An ink ejection apparatus comprising:
an ink ejector that ejects ink;
a deaeration module including a gas permeable membrane that deaerates ink;
a channel that communicates with the deaeration module;
a pump that depressurizes the channel; and
a hardware processor,
wherein when a predetermined condition under which deaeration of ink by the deaeration module is not required is met, the hardware processor at least either stops driving the pump or makes the channel to have an atmospheric pressure.

2. The ink ejection apparatus according to claim 1, wherein when the predetermined condition is not met, the hardware processor evacuates the channel.

3. The ink ejection apparatus according to claim 2, wherein when the predetermined condition is not met, the hardware processor drives the pump.

4. The ink ejection apparatus according to claim 1, wherein:
the channel includes an atmospheric relief valve configured to open and close so that the channel is connected to and disconnected from atmosphere, and
when the predetermined condition is met, the hardware processor opens the atmospheric relief valve so that the channel has the atmospheric pressure.

5. The ink ejection apparatus according to claim 1, further comprising an operation receiver that receives an operation input by a user, wherein the predetermined condition includes:
(i) the hardware processor has completed preparation for ink ejection by the ink ejector, and
(ii) the operation receiver has not received an instruction to eject ink for a predetermined time.

6. The ink ejection apparatus according to claim 1, wherein the predetermined condition includes a condition that the hardware processor has not obtained a second ink ejection job for a predetermined time since a first ink ejection job was completed by the ink ejector.

7. The ink ejection apparatus according to claim 1, wherein the predetermined condition includes a condition that the hardware processor is performing a recording medium changing process.

8. The ink ejection apparatus according to claim 1, further comprising an operation receiver that receives an operation input by a user, wherein the predetermined condition includes a condition that the operation receiver has received a predetermined operation.

9. The ink ejection apparatus according to claim 8, further comprising a cylindrical image forming drum that is provided below the ink ejector and that conveys a recording medium placed on an outer cylindrical surface of the image forming drum,
wherein the predetermined operation includes an operation of decreasing a rotation speed of the image forming drum.

10. The ink ejection apparatus according to claim 8, wherein the predetermined operation includes an operation of switching states of the ink ejection apparatus to a predetermined state in which the hardware processor determines that ink ejection by the ink ejector will not be performed for a predetermined time.

11. The ink ejection apparatus according to claim 1, further comprising a circulation channel that sends the ink that has passed through the deaeration module back to an upstream side of the deaeration module in a liquid delivery direction.

12. The ink ejection apparatus according to claim 11, wherein when the predetermined condition is not satisfied, the hardware processor flows the ink in the deaeration module into the circulation channel.

13. The ink ejection apparatus according to claim 1, wherein the ink ejector ejects ultraviolet curable ink.

14. A control method to be performed by an ink ejection apparatus that includes:
an ink ejector that ejects ink;
a deaeration module including a gas permeable membrane that deaerates ink;
a channel that communicates with the deaeration module; and
a pump that depressurizes the channel,
wherein the method comprises performing at least either (i) stopping driving the pump or (ii) making the channel to have an atmospheric pressure, when a predetermined condition under which deaeration of ink by the deaeration module is not required is met.

15. A computer-readable non-transitory storage medium storing a program for a computer of an ink ejection apparatus that includes:
an ink ejector that ejects ink;
a deaeration module including a gas permeable membrane that deaerates ink;
a channel that communicates with the deaeration module; and
a pump that depressurizes the channel,
wherein the program causes the computer to at least either (i) stop driving the pump or (ii) make the channel to have an atmospheric pressure, when a predetermined condition under which deaeration of ink by the deaeration module is not required is met.
